(19) United States
(12) Patent Application Publication
(10) Pub. No.: US 2015/0062013 A1
(43) Pub. Date: Mar. 5, 2015

(54) Rolling Shutter Synchronization of a Pointing Device in an Interactive Display System

(71) Applicant: Interphase Corporation, Carrollton, TX (US)

(72) Inventors: Yoram Solomon, Plano, TX (US); Branislav Kisacanin, Plano, TX (US); Michael Louis Zimmerman, Allen, TX (US); Charles Thomas Ferguson, Flower Mound, TX (US)

(21) Appl. No.: 14/473,516

(22) Filed: Aug. 29, 2014

Related U.S. Application Data
(60) Provisional application No. 61/871,377, filed on Aug. 29, 2013.

(51) Int. Cl. G06F 3/03; G06F 3/038; H04N 5/353; G06F 3/0354

(52) U.S. Cl. CPC G06F 3/0304; G06F 3/03545; G06F 3/0383; H04N 5/3532
USPC 345/158

(57) ABSTRACT

An interactive display system including a wireless pointing device, and positioning circuitry capable of determining absolute and relative positions of the display at which the pointing device is aimed. The pointing device captures images displayed by the computer, using a rolling shutter, the images including one or more human-imperceptible positioning targets. The positioning targets are presented as patterned modulation of the intensity (e.g., variation in pixel intensity) in a display frame of the visual payload, followed by the opposite modulation in a successive frame. At least two captured image frames are subtracted from one another to recover the positioning target in the captured visual data and to remove the displayed image payload. The capturing of images at the pointing device is synchronized with the release of image data to the display, to avoid errors in the positioning operation.

### CROSS-REFERENCE TO RELATED APPLICATIONS

This application claims priority, under 35 U.S.C. §119(e), of Provisional Application No. 61/871,377, filed Aug. 29, 2013, incorporated herein by this reference.

### STATEMENT REGARDING FEDERALLY SPONSORED RESEARCH OR DEVELOPMENT

Not applicable.

### BACKGROUND OF THE INVENTION

This invention is in the field of interactive display systems. Embodiments of this invention are more specifically directed to the positioning of the location at a display to which a control device is pointing during the interactive operation of a computer system.

The ability of a speaker to communicate a message to an audience is generally enhanced by the use of visual information, in combination with the spoken word. In the modern era, the use of computers and associated display systems to generate and display visual information to audiences has become commonplace, for example by way of applications such as the POWERPOINT presentation software program available from Microsoft Corporation. For large audiences, such as in an auditorium environment, the display system is generally a projection system (either front or rear projection). For smaller audiences such as in a conference room or classroom environment, flat-panel (e.g., liquid crystal) displays have become popular, especially as the cost of these displays has fallen over recent years. New display technologies, such as small projectors (“pico-projectors”), which do not require a special screen and thus are even more readily deployed, are now reaching the market. For presentations to very small audiences (e.g., one or two people), the graphics display of a laptop computer may suffice to present the visual information. In any case, the combination of increasing computer power and better and larger displays, all at less cost, has increased the use of computer-based presentation systems, in a wide array of contexts (e.g., business, educational, legal, entertainment).

A typical computer-based presentation involves the speaker standing remotely from the display system, so as not to block the audience's view of the visual information. Because the visual presentation is computer-generated and computer-controlled, the presentation is capable of being interactively controlled, to allow selection of visual content of particular importance to a specific audience, annotation or illustration of the visual information by the speaker during the presentation, and invocation of effects such as zooming, selecting links to information elsewhere in the presentation (or online), moving display elements from one display location to another, and the like. This interactivity greatly enhances the presentation, making it more interesting and engaging to the audience.

The ability of a speaker to interact, from a distance, with displayed visual content, is therefore desirable. More specifically, a hand-held device that a remotely-positioned operator could use to point to, and interact with, the displayed visual information is therefore desirable.

U.S. Pat. No. 8,217,997, issued Jul. 10, 2012, entitled “Interactive Display System”, commonly assigned herewith and incorporated herein by reference, describes an interactive display system including a wireless human interface device (“HID”) constructed as a handheld pointing device including a camera or other video capture system. The pointing device captures images displayed by the computer, including one or more human-imperceptible positioning targets inserted by the computer into the displayed image data. The location, size, and orientation of the recovered positioning target identify the aiming point of the remote pointing device relative to the display.

The positioning of the aiming point of the pointing device according to the approach described in the above-referenced U.S. Pat. No. 8,217,997 is performed at a rate corresponding to the frame rate of the display system. More specifically, a new position can be determined as each new frame of data is displayed, by the combination of the new frame (and its positioning target) and the immediately previous frame (and its complementary positioning target). This approach works quite well in many situations, particularly in the context of navigating and controlling a graphical user interface in a computer system, such as pointing to and “clicking” icons, click-and-drag operations involving displayed windows and frames, and the like. A particular benefit of this approach described in U.S. Pat. No. 8,217,997, is that the positioning is “absolute”, in the sense that the result of the determination is a specific position on the display (e.g., pixel coordinates). The accuracy of the positioning carried out according to this approach is quite accurate over a wide range of distances between the display and the handheld device, for example ranging from in physical contact with the display screen to tens of feet away.

U.S. Patent Application Publication No. US 2014/0062881, published Mar. 6, 2014 from copending and commonly assigned U.S. patent application Ser. No. 14/018,695, incorporated herein by this reference, describes an interactive display system including a wireless pointing device and positioning circuitry capable of determining both absolute and relative positions of the display at which the pointing device is aimed. A comparison between the absolute and relative positions at a given time is used to compensate the relative position determined by the motion sensors, enabling both rapid and frequent positioning provided by the motion sensors and also the excellent accuracy provided by absolute positioning.

U.S. Patent Application Publication No. US 2014/0111433, published Apr. 24, 2014 from copending and commonly assigned U.S. patent application Ser. No. 14/056,286, incorporated herein by this reference, describes an interactive display system including a wireless pointing device and positioning circuitry capable of detecting motion of the pointing device between the times at which two frames are captured in order to identify the aiming point of the remote pointing device relative to the display. The ability of the pointing device to detect the positioning target is improved, according to the system and method described in this publication, by aligning the two captured images with one another according to the extent and direction of the detected motion.

Conventional digital cameras typically use a “rolling shutter” mechanism to control the time that the camera sensor is exposed to incident light in obtaining the image (i.e., the “shutter speed”). As known in the art, the rolling shutter describes the technique by way of which the image frame is recorded by the sensor in a scanning manner, either vertically or horizontally, rather than by all sensor pixels capturing the image simultaneously. The rolling shutter technique improves the effective sensitivity of the sensor, because it allows the sensor to gather photons over the acquisition process. However, the rolling shutter can result in distortion in the captured image, particularly if the subject is moving during the exposure (and thus changes location from one portion of the image to another), or if a flash of light occurs during the exposure.

In the context of an interactive display system as described in the above-incorporated patents and publications, in which image capture of consecutive frames by the pointing device is used to determine the aimed at location of a display at which different and changing images or frames are displayed over time, the use of a rolling shutter can cause artifacts in the captured images. Because the rolling shutter of the pointing device is not synchronized with the display timing, part of the captured image may include pixels released to the display in one frame while another part of the captured image includes pixels released in the next frame. In this case, a visible line (i.e., a “scan line”) of low signal-to-noise ratio or a polarity reversal (i.e., part of the image having light features over dark background and another part of the same image having dark features over light background) will appear in the captured or processed image at the boundary between those frames. This rolling shutter effect can result in inaccurate or indeterminate positioning of the location of the display at which the pointing device is aimed.

### BRIEF SUMMARY OF THE INVENTION

Embodiments of this invention provide an interactive display system and method for rapidly and accurately determining an absolute position of the location at a display at which a handheld human interface device, such as a pointing device, using a rolling shutter is pointing.

Some embodiments of this invention provide such a system and method in which the pointing device can be used with a wide range of display types and technologies.

Some embodiments of this invention provide such a system and method in which such absolute positioning can be performed without requiring an external synchronization source.

Other objects and advantages of the various embodiments of this invention will be apparent to those of ordinary skill in the art having reference to the following specification together with its drawings.

Embodiments of this invention may be implemented into an interactive display system and method of operating the same in which a pointing device includes an image capture subsystem, using a rolling shutter, for identifying an absolute location at a displayed image. The pointing device operates by detecting a “scan line”, which is a boundary in the captured image that appears between pixels scanned in different frames; the scan line is present when the image capture by the pointing device is not synchronized with the timing at which frames are released to the display. Circuitry in the pointing device operates to determine the phase difference required to move the scan line to a point outside of the visible pixel data. Other circuitry operates to adjust the phase of one of the pointing device shutter and the display frame scan according to the determined phase difference.

### BRIEF DESCRIPTION OF THE SEVERAL VIEWS OF THE DRAWING

FIGS. 1a and 1b are schematic perspective views of a speaker presentation being carried out using an interactive display system according to embodiments of the invention.

FIGS. 2a through 2c are electrical diagrams, in block form, each illustrating an interactive display system according to an embodiment of the invention.

FIG. 3 is a flow diagram illustrating an example of the operation of the recovery of positioning targets as used in connection with some embodiments of the invention.

FIG. 4a is a timing diagram illustrating examples of the synchronized and mis-synchronized image capture and frame release in the operation of the systems of FIGS. 2a through 2c.

FIG. 4b through 4h are illustrations of captured images and subtracted images illustrating the effects of synchronized and mis-synchronized image capture and frame release in the operation of the systems of FIGS. 2a through 2c.

FIG. 5 is a flow diagram illustrating the operation of the systems of FIGS. 2a and 2c in synchronizing image capture and frame release according to an embodiment of the invention.

FIGS. 6a through 6c are flow diagrams illustrating the operation of scan line detection in the process of FIG. 5 according to embodiments of the invention.

FIGS. 7a and 7b are flow diagrams illustrating the operation of phase adjustment in the process of FIG. 5 according to embodiments of the invention.

FIGS. 8a through 8c are flow diagrams illustrating the operation of optional frequency synchronization as useful in the process of FIG. 5 according to embodiments of the invention.

### DETAILED DESCRIPTION OF THE INVENTION

This invention will be described in connection with one or more of its embodiments, namely as implemented into a computerized presentation system including a display visible by an audience, as it is contemplated that this invention will be particularly beneficial when applied to such a system. However, it is also contemplated that this invention can be useful in connection with other applications, such as gaming systems, general input by a user into a computer system, and the like. Accordingly, it is to be understood that the following description is provided by way of example only, and is not intended to limit the true scope of this invention as claimed.

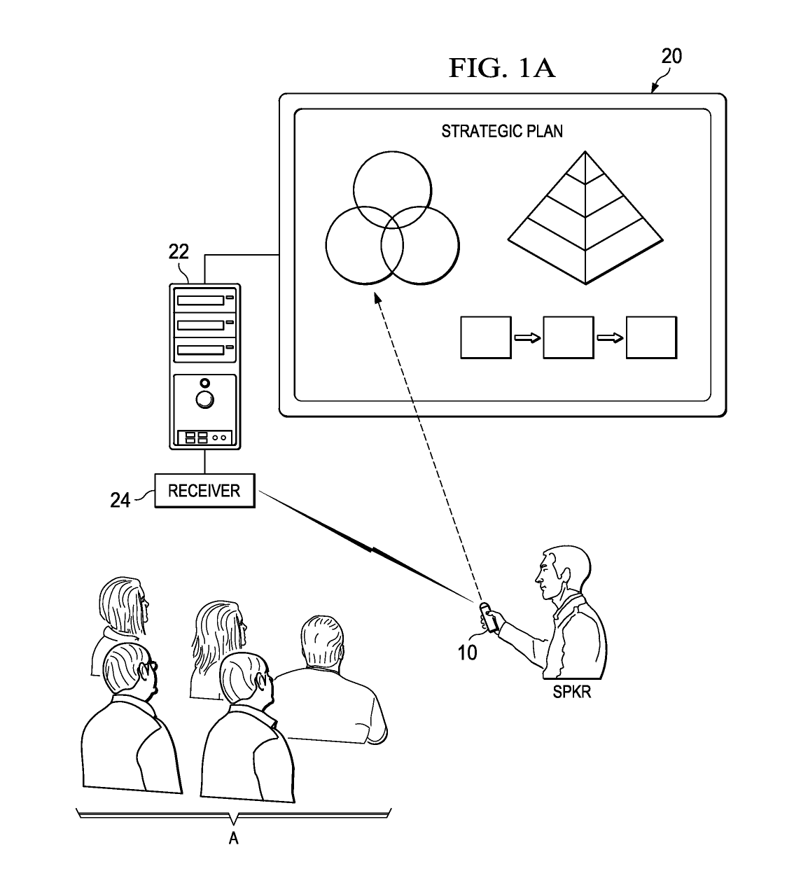

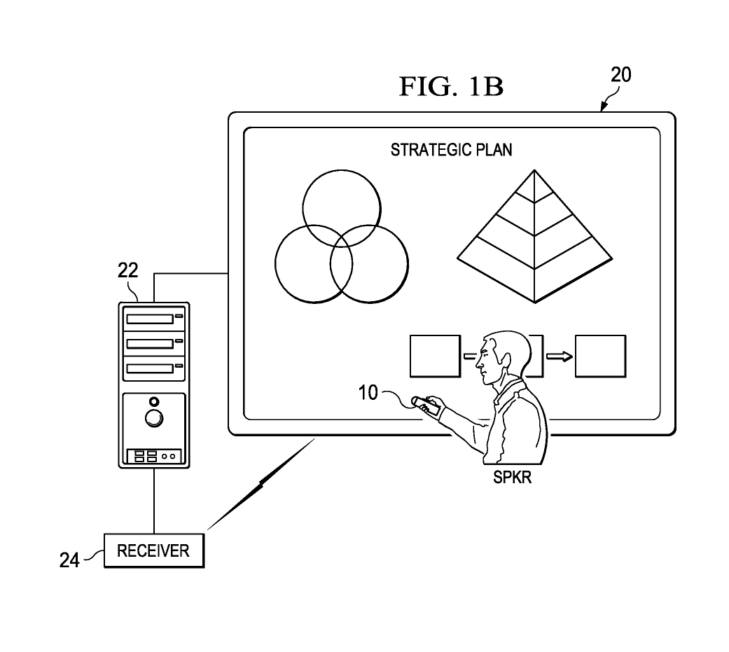

FIG. 1a illustrates a simplified example of an environment in which embodiments of this invention are useful. As shown in FIG. 1a, speaker SPKR is giving a live presentation to audience A, with the use of visual aids. In this case, the visual aids are in the form of computer graphics and text, generated by computer 22 and displayed on room-size graphics display 20, in a manner visible to audience A. As known in the art, such presentations are common in the business, educational, entertainment, and other contexts, with the particular audience size and system elements varying widely. The simplified example of FIG. 1a illustrates a business environment in which audience A includes several or more members viewing the presentation; of course, the size of the environment may vary from an auditorium, seating hundreds of audience members, to a single desk or table in which audience A consists of a single person.

The types of display 20 used for presenting the visual aids to audience A can also vary, often depending on the size of the presentation environment. In rooms ranging from conference rooms to large-scale auditoriums, display 20 may be a projection display, including a projector disposed either in front of or behind a display screen. In that environment, computer 22 would generate the visual aid image data and forward it to the projector. In smaller environments, display 20 may be an external flat-panel display, such as of the plasma or liquid crystal display (LCD) type, directly driven by a graphics adapter in computer 22. For presentations to one or two audience members, computer 22 in the form of a laptop or desktop computer may simply use its own display 20 to present the visual information. Also for smaller audiences A, hand-held projectors (e.g., “pocket projectors” or “pico projectors”) are becoming more common, in which case the display screen may be a wall or white board.

The use of computer presentation software to generate and present graphics and text in the context of a presentation is now commonplace. A well-known example of such presentation software is the POWERPOINT software program available from Microsoft Corporation. In the environment of FIG. 1a, such presentation software will be executed by computer 22, with each slide in the presentation displayed on display 20 as shown in this example. Of course, the particular visual information need not be a previously created presentation executing at computer 22, but instead may be a web page accessed via computer 22; a desktop display including icons, program windows, and action buttons; video or movie content from a DVD or other storage device being read by computer 22. Other types of visual information useful in connection with embodiments of this invention will be apparent to those skilled in the art having reference to this specification.

In FIG. 1a, speaker SPKR is standing away from display 20, so as not to block the view of audience A and also to better engage audience A. According to embodiments of this invention, speaker SPKR uses a handheld human interface device (HID), in the form of pointing device 10, to remotely interact with the visual content displayed by computer 22 at display 20. This interactive use of visual information displayed by display 20 provides speaker SPKR with the ability to extemporize the presentation as deemed useful with a particular audience A, to interface with active content (e.g., Internet links, active icons, virtual buttons, streaming video, and the like), and to actuate advanced graphics and control of the presentation, without requiring speaker SPKR to be seated at or otherwise “pinned” to computer 22.

FIG. 1b illustrates another use of the system and method of embodiments of this invention, in which speaker SPKR closely approaches display 20 to interact with the visual content. In this example, display 20 is operating as a “white board” on which speaker SPKR may “draw” or “write” using pointing device 10 to actively draw content as annotations to the displayed content, or even on a blank screen as suggested by FIG. 1b. Typically, this “drawing” and “writing” would be carried out while placing pointing device 10 in actual physical contact with, or at least in close proximity to, display 20. The hardware, including display 20, in the application of FIG. 1b may be identical to that in the presentation example of FIG. 1a; indeed, embodiments of this invention allow the same speaker SPKR may interact with the same presentation in front of the same audience both from a distance as shown in FIG. 1a, and at display 20 as shown in FIG. 1b.

In either case, as described in the above-incorporated U.S. Pat. No. 8,217,997, in the above-incorporated U.S. Patent Application Publications No. US 2014/0062881 and No. US 2014/0111433, and in further detail below in connection with particular embodiments of the invention, speaker SPKR carries out this interaction by way of pointing device 10, which is capable of capturing all or part of the image at display 20 and of interacting with a pointed-to (or aimed-at) target location at that image. Pointing device 10 in the examples of FIGS. 1a and 1b wirelessly communicates this pointed-to location at display 20 and other user commands from speaker SPKR, to receiver 24 and thus to computer 22. In this manner, according to embodiments of this invention, remote interactivity with computer 22 is carried out.

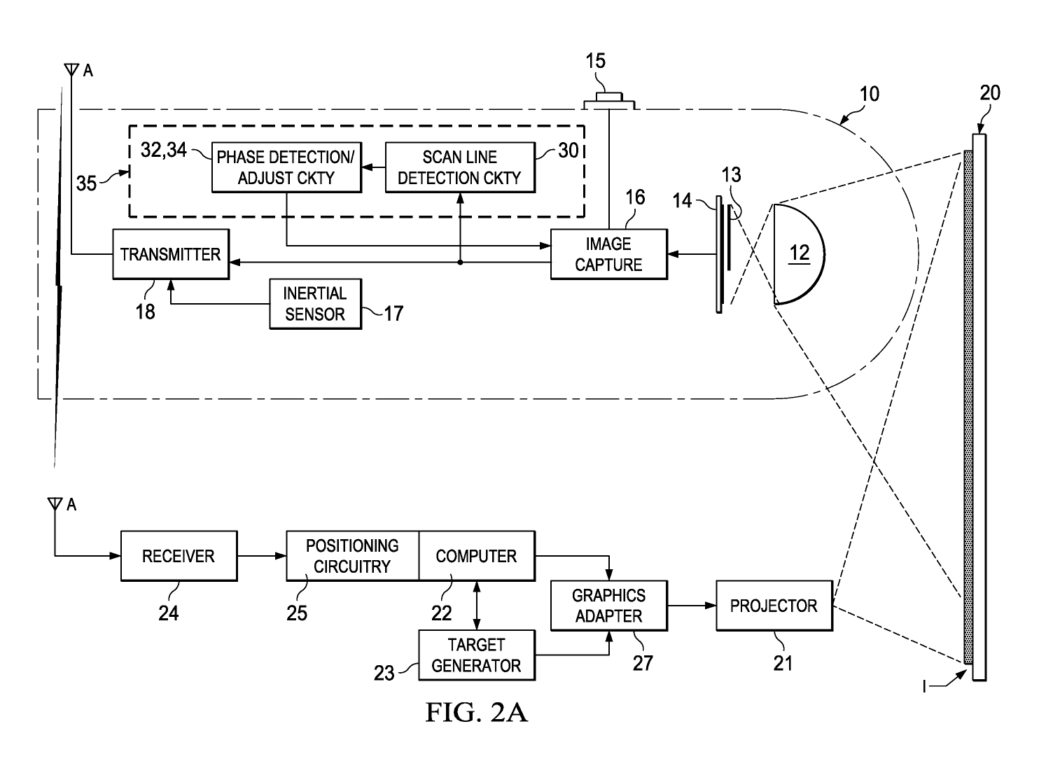

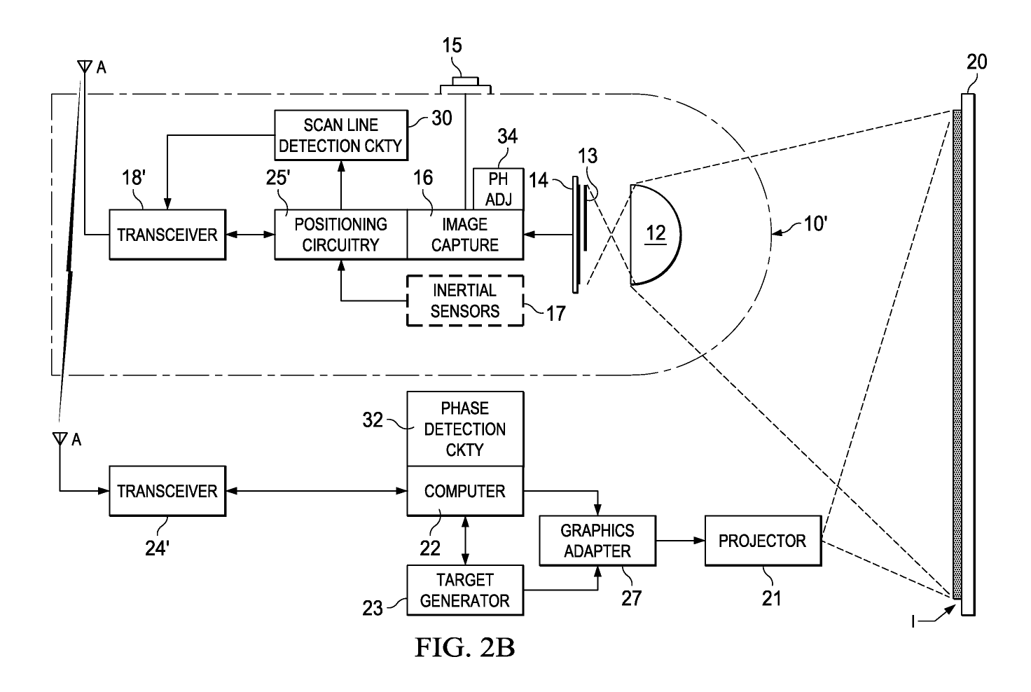

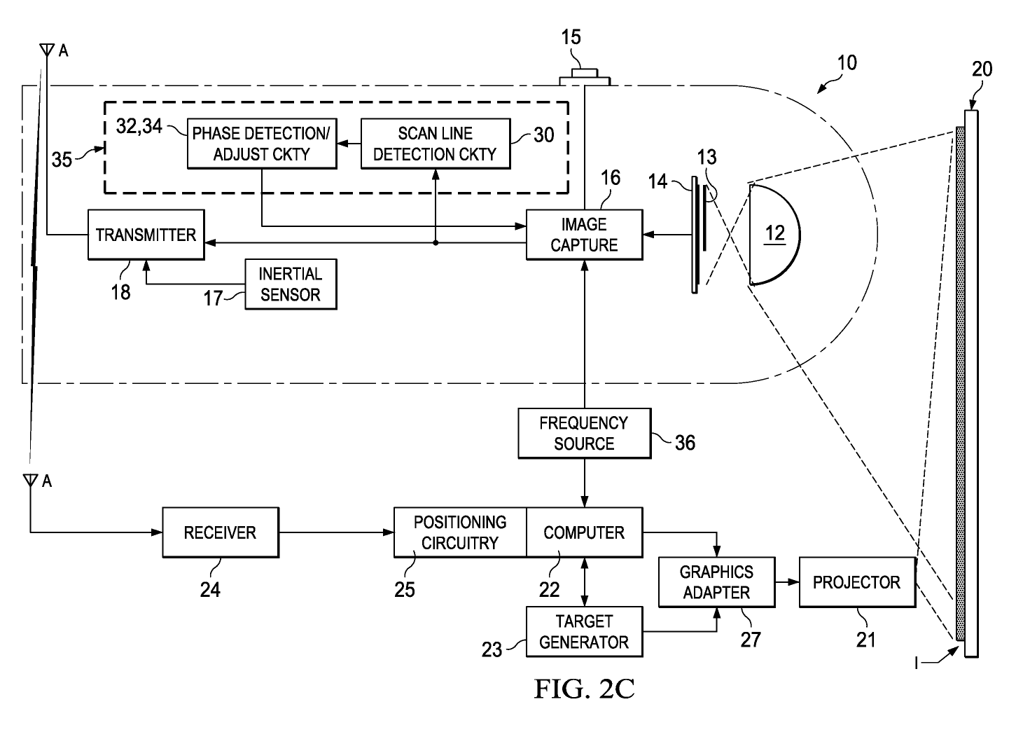

Referring to FIG. 2a, a generalized example of the construction of an interactive display system useful in environments such as those shown in FIGS. 1a and 1b, according to embodiments of this invention, will now be described. As shown in FIG. 2a, this interactive display system includes pointing device 10, projector 21, and display screen 20. In this embodiment of the invention, computer 22 includes the appropriate functionality for generating the “payload” images to be displayed at display screen 20 by projector 21, such payload images intended for viewing by the audience. The content of these payload images is interactively controlled by a human user via pointing device 10, according to embodiments of this invention. To do so, computer 22 cooperates with positioning circuitry 25, which determines the position of display screen 20 to which pointing device 10 is pointing. As will become apparent from the following description, this positioning determination is based on pointing device 10 detecting one or more positioning targets displayed at display screen 20.

In its payload image generation function, computer 22 will generate or have access to the visual information to be displayed (i.e., the visual “payload” images), for example in the form of a previously generated presentation file stored in memory, or in the form of active content such as computer 22 may retrieve over a network or the Internet; for a “white board” application, the payload images will include the inputs provided by the user via pointing device 10, typically displayed on a blank background. This human-visible payload image frame data from computer 22 will be combined with positioning target image content generated by target generator function 23 that, when displayed at graphics display 20, can be captured by pointing device 10 and used by positioning circuitry 25 to deduce the location pointed to by pointing device 10. Graphics adapter 27 includes the appropriate functionality suitable for presenting a sequence of frames of image data, including the combination of the payload image data and the positioning target image content, in the suitable display format, to projector 21. Projector 21 in turn projects the corresponding images I at display screen 20, in this projection example.

The particular construction of computer 22, positioning circuitry 25, target generator circuitry 23, and graphics adapter 27 can vary widely. For example, it is contemplated that a single personal computer or workstation (in desktop, laptop, or other suitable form), including the appropriate processing circuitry (CPU, or microprocessor) and memory, can be constructed and programmed to perform the functions of generating the payload images, generating the positioning target, combining the two prior to or by way of graphics adapter 27, as well as receiving and processing data from pointing device 10 to determine the pointed-to location at the displayed image. Alternatively, it is contemplated that separate functional systems external to computer 22 may carry out one or more of the functions of target generator 23, receiver 24, and positioning circuitry 25, such that computer 22 can be realized as a conventional computer operating without modification; in this event, graphics adapter 27 could itself constitute an external function (or be combined with one or more of the other functions of target generator 23, receiver 24, and positioning circuitry 25, external to computer 22), or alternatively be realized within computer 22, to which output from target generator 23 is presented. Other various alternative implementations of these functions are also contemplated. In any event, it is contemplated that computer 22, positioning circuitry 25, target generator 23, and other functions involved in the generation of the images and positioning targets displayed at graphics display 20, will include the appropriate program memory in the form of computer-readable media storing computer program instructions that, when executed by its processing circuitry, will carry out the various functions and operations of embodiments of the invention as described in this specification. It is contemplated that those skilled in the art having reference to this specification will be readily able to arrange the appropriate computer hardware and corresponding computer programs for implementation of these embodiments of the invention, without undue experimentation.

Pointing device 10 in this example includes a camera function consisting of optical system 12 and image sensor 14. In this example, shutter 13 of the conventional type (e.g., a mechanical shutter) is implemented as part of image sensor 14, and controls the exposure of sensor 14 to light when actuated. Alternatively, shutter 13 may be implemented at or within optical system 12. In the embodiments described in this specification, shutter 13 is of the “rolling shutter” type, in that its opening effectively scans across the pixel field of sensor 14, either horizontally or vertically, which improves the sensitivity of sensor 14 and thus the quality of the captured image, as known in the art. With pointing device 10 aimed at display 20, image sensor 14 is exposed with the captured image via shutter 13, that captured image corresponding to all or part of image I at display 20, depending on the distance between pointing device 10 and display 20, the focal length of lenses within optical system 12, and the like. Image capture subsystem 16 includes the appropriate circuitry known in the art for acquiring and storing a digital representation of the captured image at a particular point in time selected by the user, or as captured at each of a sequence of sample times, including the circuitry that controls the timing and duration of the opening of shutter 13. Pointing device 10 also includes actuator 15, which is a conventional push-button or other switch by way of which the user of pointing device 10 can provide user input in the nature of a mouse button, to actuate an image capture, or for other functions as will be described below and as will be apparent to those skilled in the art. In this example, one or more inertial sensors 17 are also included within pointing device 10, to assist or enhance user interaction with the displayed content; examples of such inertial sensors include accelerometers, magnetic sensors (i.e., for sensing orientation relative to the earth's magnetic field), gyroscopes, and other inertial sensors.

In this example of FIG. 2a, pointing device 10 is operable to forward, to positioning circuitry 25, signals that correspond to the captured image acquired by image capture subsystem 16. This communications function is performed by wireless transmitter 18 in pointing device 10, along with its internal antenna A, by way of which radio frequency signals (e.g., according to a conventional standard such as Bluetooth or the appropriate IEEE 802.11 standard) are transmitted. Transmitter 18 is contemplated to be of conventional construction and operation for encoding, modulating, and transmitting the captured image data, along with other user input and control signals via the applicable wireless protocol. In this example, receiver 24 is capable of receiving the transmitted signals from pointing device 10 via its antenna A, and of demodulating, decoding, filtering, and otherwise processing the received signals into a baseband form suitable for processing by positioning circuitry 25.

It is contemplated that the particular location of positioning circuitry 25 in the interactive display system of embodiments of this invention may vary from system to system. It is not particularly important, in the general sense, which hardware subsystem (i.e., the computer driving the display, the pointing device, a separate subsystem in the video data path, or some combination thereof) performs the determination of the pointed-to location at display 20. In the example shown in FIG. 2a, as described above, positioning circuitry 25 is deployed in combination with computer 22 and target generator function 23, in a system that combines the functions of generating the displayed images I and of determining the location at the displayed images I at which pointing device 10 is aimed (and decoding the commands associated therewith) into the same element of the system.

According to embodiments of this invention, the interactive display system includes scan line detection circuitry 30, phase detection circuitry 32, and phase adjustment circuitry 34. In the example of FIG. 2a, each of these functions are implemented in pointing device 10, indeed with phase detection circuitry 32 and phase adjustment circuitry 34 realized by a single combined function; more specifically, these functions are implemented by way of a programmable processor 35 that executes instructions stored in its program memory (not shown) to carry out the operations of these functions as will be described below. Alternatively, of course, phase detection circuitry 32 and phase adjustment circuitry 34 may be realized by separate programmable or other logic functions, both within pointing device 10 or in separate devices, as will be described by example below. As will be described below and as otherwise evident to those skilled in the art having reference to this specification, scan line detection circuitry 30, phase detection circuitry 32, and phase adjustment circuitry 34 may be realized in a wide variety of ways, including with one or more of those functions realized external to pointing device 10 such as within or in combination with computer 22.

In the example of FIG. 2a, scan line detection circuitry 30 receives captured image data from image capture subsystem 16, and performs the appropriate graphics processing operations described below to determine the presence and position of a “scan line” within the acquired images. As will become evident from this specification, the position of this scan line will be indicative of the relative phase between the image capture of subsystem 16 and the releasing of frames by graphics adapter 27 to projector 21. In this embodiment, phase detection/adjustment circuitry 32, 34 operates to determine this relative phase from the position of the scan line detected by circuitry 30, and to adjust the phase of image capture 16 so as to be synchronized with the release of frames to projector 21.

FIG. 2b illustrates an alternative generalized arrangement of an interactive display system according to embodiments of this invention. This system includes projector 21 and display 20 as in the example of FIG. 2b, with projector 21 projecting payload image content and positioning target image content generated by computer 22 as described above. In this example, pointing device 10′ performs some or all of the computations involved in determining the location at display 20 at which it is currently pointing. As such, in addition to a camera (lens 12, image sensor 14, and image capture 16), positioning device 10′ includes positioning circuitry 25′, along with wireless transceiver 18′. Conversely, computer 22 is coupled to transceiver 24′. In this example, transceivers 18′, 24′ are capable of both receiving and transmitting wireless communications with one another, in which case data corresponding to the size, shape, and position of the positioning targets as displayed at display 20 can be transmitted to pointing device 10′ for comparison.

In the example of the interactive display system shown in FIG. 2b, scan line detection circuitry 30 and phase adjustment circuitry 34 are implemented in pointing device 10′, while phase detection circuitry 32 is realized by or in combination with computer 22. In this case, the position of the scan line as detected by circuitry 30 is communicated by transceiver 18′ of pointing device 10′ to transceiver 24′, which communicates those results to phase detection circuitry 32. In this embodiment, phase detection circuitry 32 operates to determine the relative phase between the image capture of subsystem 16 and the releasing of frames by graphics adapter 27 to projector 21, based on the position of the scan line detected by circuitry 30, and communicates that phase difference to phase adjustment circuitry 34 in pointing device 10′, via the communications link between transceivers 24′ and 18′. Phase adjustment circuitry 34 adjusts the phase of image capture 16 according to that detected phase difference, to synchronize image capture by subsystem 16 with the release of frames to projector 21.

FIG. 2c illustrates an alternative architecture of the interactive display system, according to an embodiment of this invention. This architecture arranges pointing device 10 and positioning circuitry 25 in the manner described above relative to FIG. 2a. In the embodiment of FIG. 2c, external frequency source 36 is connected to both pointing device 10 and computer 22. External frequency source 36 includes conventional clock reference circuitry, such as a crystal oscillator and associated circuitry that generates clock signals based on the periodic output from the crystal oscillator, frequency synthesis circuitry, or the like for generating a relatively stable periodic clock signals. In this embodiment, pointing device 10 and computer 22 (or, alternatively, graphics adaptor 27 or projector 21, as the case may be) are synchronized in frequency to a clock signal from external frequency source 36, so that the frequency at which image capture subsystem 16 acquires images and the rate at which display frames are “released” to display 20 are at the same frequency or rate. This external frequency synchronization assists in the operation of some embodiments of the invention, as will be described in detail below.

In any of these cases, positioning circuitry 25, 25′ (hereinafter referred to generically as positioning circuitry 25) determines the location at display 20 at which pointing device 10, 10′ (hereinafter referred to generically as pointing device 10) is aimed, as will be described in detail below. As described in the above-incorporated U.S. Pat. No. 8,217,997 and in the above-incorporated U.S. Patent Application Publications No. US 2014/0062881 and No. US 2014/0111433, positioning circuitry 25 performs “absolute” positioning, in the sense that the pointed-to location at the display is determined with reference to a particular pixel position within the displayed image. As described in U.S. Pat. No. 8,217,997 and in U.S. Patent Application Publications No. US 2014/0062881 and No. US 2014/0111433, image capture subsystem 16 captures images from two or more frames, those images including one or more positioning targets that are presented as patterned modulation of the intensity (e.g., variation in pixel intensity) in one display frame of the visual payload, followed by the same pattern but with the opposite modulation in a later (e.g., the next successive) frame.

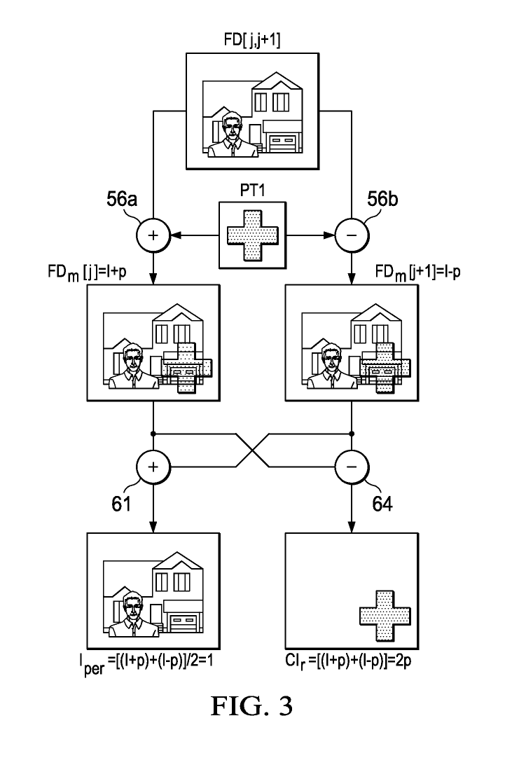

FIG. 3 illustrates a simplified example of frame data FD[j] for an image data frame/generated by computer 22 for display via projector 21 onto display screen 20, showing the visual content intended for viewing by the audience. In operation, these frame data FD[j] are combined with a positioning target PT1 by modifying the intensity data for those pixels within the positioning target shape by a differential intensity Δ value previously determined. In modifying operation 56a performed by computer 22 for frame j, this intensity Δ value is added, on a pixel by pixel basis, to the intensity value for each pixel within the positioning target shape at its selected location; the intensity values of pixels outside of the positioning target are not modified. FIG. 3 illustrates a simplified example of the result of this modification by way of modified frame data FDₘ[j], in which the cross-shaped positioning target PT1 appears as brighter values at the selected location in the lower right-hand quadrant of the image data forwarded to projector 21 for display at display 20 for this frame. Combining process 56b for the next frame j+1 of visual payload image frame data similarly subtracts the differential intensity Δ value from the payload intensity for pixels within the positioning target PT1; the intensity values of pixels outside of the positioning target are not modified. For this frame, as shown in FIG. 3, modified frame data FDₘ[j+1] includes cross-shaped positioning target PT1 as dimmer values, at the same selected location in the lower right-hand quadrant of the image data forwarded to projector 21 for display at display 20.

For purposes of this description, the intensity modification applied for the positioning target is described in a monochromatic sense, with the overall intensity of each pixel described as modulated either brighter or dimmer at the positioning target. Of course, modern displays are color displays, typically realized based on frame data with different intensities for each component color (e.g., red, green, blue). As such, it is contemplated for some embodiments of this invention that the intensity of each component color would be modulated by ±p at the positioning target locations; alternatively, the modulation may vary from color to color.

This process is then repeated for the next frames j+2, j+3, etc., resulting in a sequence of images displayed at display 20, with one or more positioning targets appearing in successive frames, but alternating between being brighter and being dimmer in those successive frames. Because the response of the human eye is generally too slow to perceive individual display frames at modern frame rates on the order of 60 Hz or higher, human viewers will tend to average the perceived displayed images. Referring to FIG. 3, the result of this averaging is to sum (adder 61) successive frames j, j+1, and then average the intensity over time. In this case in which frames successive frames j, j+1 include positioning target PT1 of complementary modulation, this summing cancels out the positioning target images, so the human viewer naturally perceives the visual payload image data only, and does not directly perceive the positioning target or shape. This human-visible frame is shown as image Iₚₑᵣ in FIG. 3.

As described in U.S. Pat. No. 8,217,997 and in U.S. Patent Application Publications No. US 2014/0062881 and No. US 2014/0111433, however, the interactive display system is capable of detecting and identifying the positioning target included within the displayed image I. In summary, image capture subsystem 16 captures images from each of frames j and j+1, each captured image including image data containing the payload image FD(j,j+1) and the complementary positioning target PT1. Positioning circuitry 25 (whether located at computer 22 as in FIG. 2a, or in pointing device 10′ as in FIG. 2b), subtracts the image data of captured image frame j+1 from captured image frame j, on a pixel-by-pixel basis. As shown in FIG. 3, subtraction 64 results in the visual payload image data effectively canceling out, and in reinforcement of positioning target PT1. As such, after subtraction process 64, positioning device 10 perceives only the positioning target or shape, and does not perceive the visual payload image data, as shown by image CIᵣ of FIG. 3.

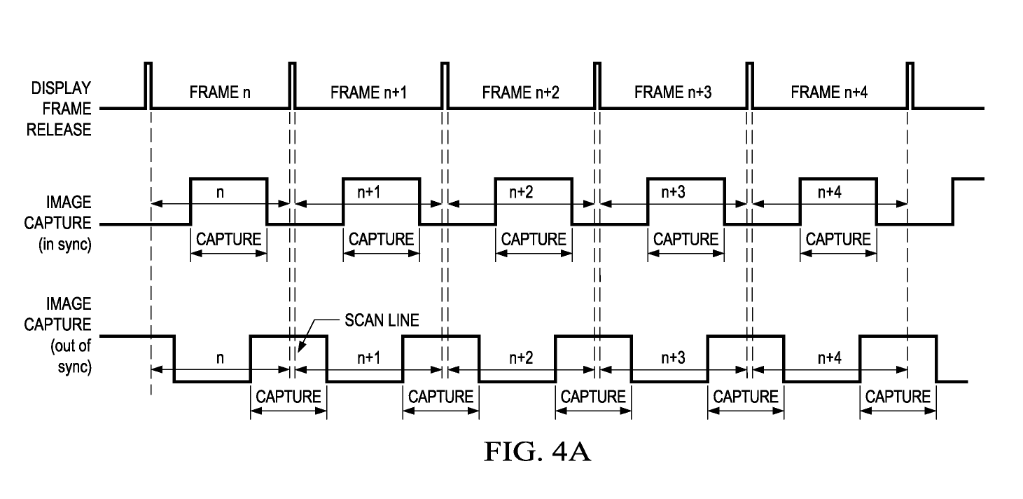

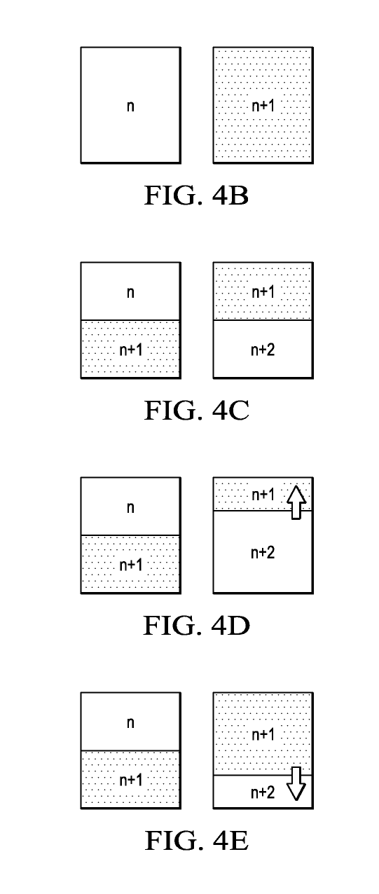

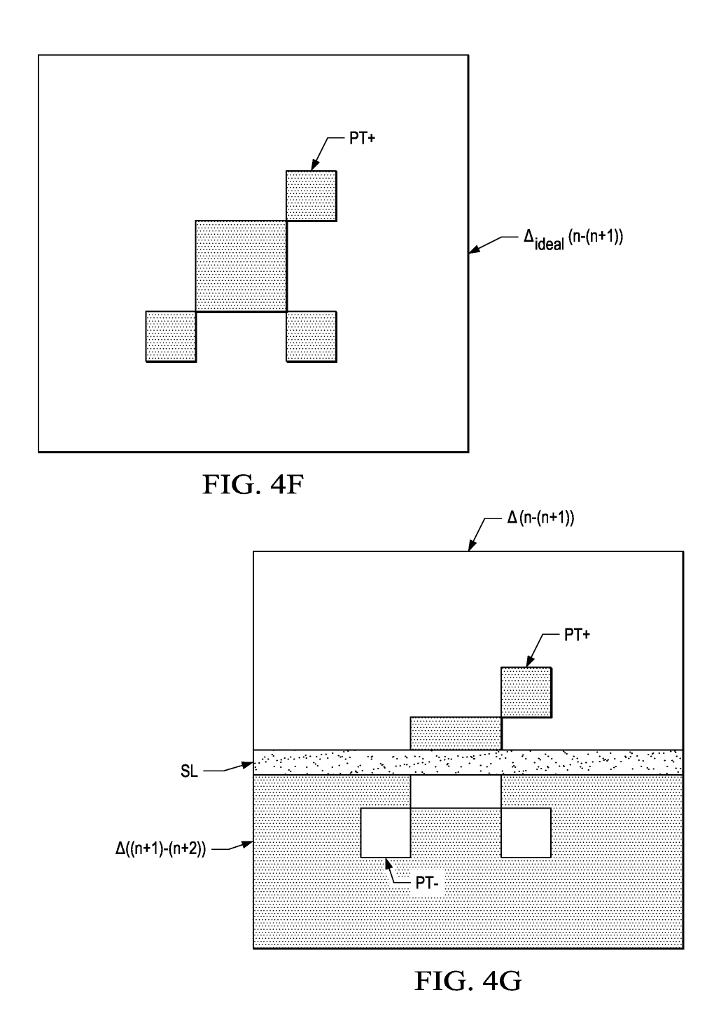

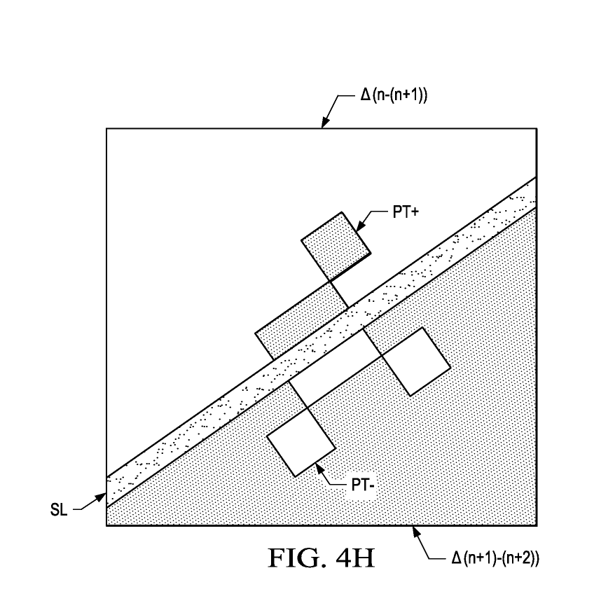

This positioning operation summarized above relative to FIG. 3 assumes that image capture subsystem 16 operates so that each captured image accurately corresponds to one and only one image frame projected at display 20. However, it has been discovered, in connection with this invention, that the conventional “rolling shutter” used in modern digital cameras to control exposure can render this assumption invalid, as will now be discussed relative to FIGS. 4a through 4h.

The top plot in FIG. 4a illustrates the timing at which a image data for a frame to be displayed at display 20 is “released” for display, for example by projector 21 changing its pixels from the image data from a previous frame to a new frame. The particular timing of this “release” of image data may be controlled by graphics adaptor 27 of the system of FIGS. 2a and 2b, or in such other manner as conventional. For purposes of this description, we will use the term “released” to mean the changing of pixels in the display from frame to frame. It is contemplated, of course, that the particular reference time (i.e., frame “release” time) may correspond to another event in the display of a frame, for example a vertical sync pulse in a scanned display, or another event further upstream in the display channel; in that event, it is contemplated that the actual changing of pixels at the display will occur at a relatively constant time delay (constant from frame to frame) from the reference time considered as the frame “release”, such that phase and frequency differences may be calculated for purposes of embodiments of this invention, as will be described below.

The middle plot of FIG. 4a illustrates an example of the timing of the rolling shutter exposure carried out by shutter 13 of pointing device 10 in the interactive display system of this embodiment. In this example, a high logic level on line “IMAGE CAPTURE (in sync)” indicates that at least part of sensor 14 is being exposed to the image at display 20; for purposes of this description, we will consider this exposure to be horizontally rolling, such that the pixels of sensor 14 receiving the top lines of display 20 are exposed during the earliest part of the pulse, sensor pixels receiving the middle lines of display 20 are exposed in the middle of the pulse, and those sensor pixels receiving the bottom lines of display 20 are exposed at the end of the pulse. In this “in sync” condition, the entire exposure is contained within the duration of a single frame, such that each displayed frame is accurately captured. FIG. 4b illustrates the images as captured for frames n and n+1 in this “in sync” condition; frame n+1 is shown as shaded merely to distinguish it from frame n.

However, if the image capture carried out by pointing device 10 is asynchronous relative to the release of frames to display 20 by graphics adaptor 27, this “in sync” condition is a matter of happenstance. The bottom plot of FIG. 4a illustrates an example of the timing of the rolling shutter exposure carried out by shutter 13 of pointing device 10 in the condition in which shutter 13 is “out of sync” with the release of frames to display 20. In this “out of sync” condition, the early portion of each exposure is within the duration of one frame (e.g., frame n), while the later portion of that exposure is within the duration of the next frame (e.g., frame n+1). Because shutter 13 is a rolling shutter in this example, this “out of sync” condition results in the pixels of part of sensor 14 receiving the image from one frame and the pixels of another part of sensor 14 receiving the image from the next frame. FIG. 4c illustrates the images captured according to the timing shown in the bottom plot of FIG. 4a, in which one exposure receives the upper portion of frame n and the lower portion of frame n+1, and the next exposure receives the upper portion of frame n+1 and the lower portion of frame n+2.

The illustration of FIG. 4c illustrates the case in which the frequency of image capture is the same as the rate at which frames are released to display, because the line between frames is at about the same position in the middle of the captured image in both of the captured images. However, this frequency synchronization is also often not the case with an asynchronous image capture system 16 relative to display 20. For example, if the image capture frequency is faster than the rate at which frames are released to display 20, the boundary between frames in the captured image will move upward from image to image, as shown in FIG. 4d. Conversely, if the image capture frequency is slower than the frame release rate, then the boundary between frames in the captured image will move downwardly, as shown in FIG. 4e.

The effects of mis-synchronization between image capture subsystem 16 and the release of frames to display 20 is especially disruptive to the positioning operation described above relative to FIG. 3, in which the image data of successive captured images are subtracted from one another in order to recover the positioning target. FIG. 4f illustrates an example of an ideal subtracted frame Δ_{idea}(n−(n+1)) resulting from the subtraction of successive frames n, n+1 captured in the “in sync” condition as shown in FIG. 4b. In that ideal subtracted frame Δ_{ideal}(n−(n+1)), the human-visible images cancel one another out, as described above, and human-imperceptible positioning target PT+ is recovered. Positioning circuitry 25 is thus readily able to determine the location of display 20 at which pointing device 10 is aimed, according to the approaches described in described in U.S. Pat. No. 8,217,997 and in U.S. Patent Application Publications No. US 2014/0062881 and No. US 2014/0111433.

However, the effects of mis-synchronization between image capture and display frame release drastically affects the fidelity of the recovery of positioning targets according to this subtraction technique. FIG. 4g illustrates the result of the subtraction of the images captured in the “out of sync” condition as shown in FIG. 4c. In this case, subtraction of the two images of FIG. 4c results in an upper frame portion Δ(n−(n+1)) and a lower portion Δ((n+1)−(n+2)), in which the upper frame portion Δ(n−(n+1)) corresponds essentially to the corresponding portion of ideal subtracted frame Δ_{idea}(n−(n+1)) of FIG. 4f, including positioning target PT+ that appears as a dark figure on a light background. However, the lower portion Δ((n+1)−(n+2)) appears largely as would a negative (dark portions are light, light portions dark) of the corresponding lower portion of ideal subtracted frame Δ_{idea}(n−(n+1)) of FIG. 4f. In particular, positioning target PT− in this lower portion Δ((n+1)−(n+2)) of FIG. 4g appears as a light figure on a dark background, opposite from positioning target PT+ in the upper portion. This reversal of part of the expected recovered positioning target of course complicates the positioning process, considering that it will be difficult for positioning circuitry 25 to recognize the image of FIG. 4g as containing a positioning target that resembles the expected form of positioning target PT+ in FIG. 4f.

In addition, the idealized illustration of FIG. 4c shows the case in which the width of the opening of shutter 13 is a single line of pixels at sensor 14. However, multiple rows of pixels of sensor 14 are typically exposed at any given instant during the rolling shutter exposure. As such, those sensor pixels that are exposed during the time at which a frame is released to display 20 (the pulse in the top plot of FIG. 4a) will receive light from both image frames. In particular, the idealized captured images of FIG. 4c will include a portion along the boundary between the partial frames that receive some light from both of the frames. Subtraction of the images to recover the positioning target has been observed to result in a band of noise along that border. FIG. 4g illustrates that noise band SL surrounding the boundary between upper frame portion Δ(n−(n+1)) and lower frame portion Δ((n+1)−(n+2)). For purposes of this description, that band SL will be referred to as a “scan line”. This scan line SL corresponds to the portion of the images captured during the release of a new frame to display 20, which occurs during the time intervals “SCAN LINE” shown in the bottom plot of FIG. 4a.

The width of noise band SL will depend on the time required to release and display a new frame at display 20, relative to the rolling shutter interval. A longer frame release interval and/or a shorter rolling shutter exposure time will result in a wider scan line noise band SL in the subtracted images if the shutter is open during that frame release time, because the frame release interval will correspond to a larger portion of the captured images. As such, mis-synchronization of the image capture time with the frame release time can result in a subtracted image that is largely noise, and thus of little use for positioning purposes.

FIG. 4h illustrates another complication that can arise from mis-synchronized image capture. As evident from the above description of the interactive display system, pointing device 10 can be held by the user in various attitudes. The images captured and subtracted in the positioning process can themselves be rotated. FIG. 4h illustrates an example of such a rotation; in this case, scan line SL is at an angle from the horizontal. This rotation of the noisy and partially reversed positioning targets further complicates the positioning process.

According to embodiments of the invention, the image capture process by pointing device 10 is synchronized with the release of frames to display 20, such that each image captured by pointing device 10 for positioning purposes corresponds to one and only one image frame displayed at display 20, and does not include scan line noise or image information from multiple frames. In a general sense according to these embodiments, one may consider the synchronization problem as involving the synchronization of both frequency (i.e., the image capture rate should match the frame release rate) and phase (i.e., the timing of image capture should occur at a desired time relative to the frame release cycle). Frequency synchronization could be accomplished in a master/slave fashion by having the display system (computer 22, graphics adaptor 27, or display 20) as the master and pointing device 10 as the slave, or having pointing device 10 be the master and the display system as the slave, or having both the display system and pointing device 10 slaved to an external master device. However, the interactive display system described above and in U.S. Pat. No. 8,217,997 and U.S. Patent Application Publications No. US 2014/0062881 and No. US 2014/0111433 desirably allows pointing device 10 to operate with multiple display systems, most if not all of which may be pre-installed without regard to a particular pointing device. As such, it may not be practical in many instances to provide such a master/slave arrangement to attain frequency synchronization. Embodiments of this invention therefore control the synchronization of image capture relative to frame release, in other words reducing the phase difference between those events so that the undesired artifacts described above do not appear in the subtracted image data used for positioning purposes.

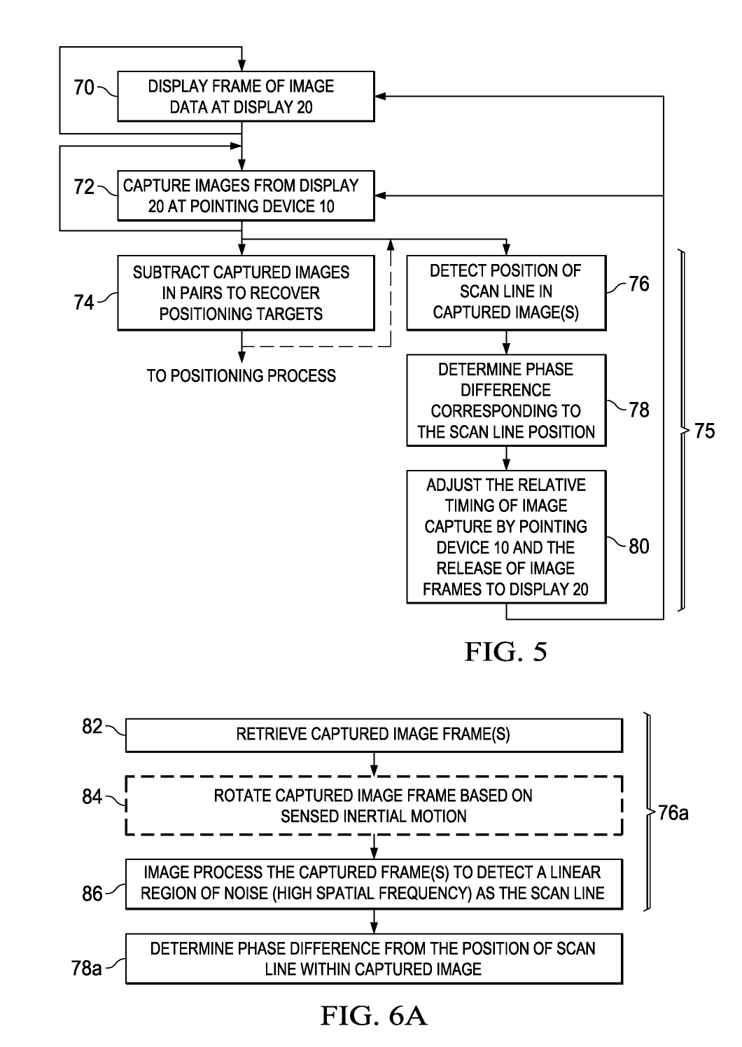

Referring now to FIG. 5, a method of operating the interactive display system of FIGS. 2a through 2c according to embodiments of this invention will now be described. As discussed above, certain of the functions involved in the synchronization process, such as scan line detection circuitry 30, phase detection circuitry 32, and phase adjustment circuitry 34, may be deployed in either of pointing device 10, 10′ or in or with computer 22. As such, this description will refer to those functions regardless of where deployed, unless specifically referred to as being implemented in a particular component of the system for a given instance.

Synchronization of image capture at pointing device 10 (or pointing device 10′, as the case may be; for purposes of clarity, the following description will refer to either of these pointing devices as pointing device 10) with the release of frames to display 20 begins with process 70, in which image frames are displayed at display 20 by the operation of computer 22, target generator 23, graphics adaptor 27, and projector 21 as described above in connection with FIGS. 2a through 2c. Display process 70 repeats itself at the nominal display rate (i.e., frame rate, or refresh rate), displaying the desired output on display 20. Meanwhile, in process 72, image capture subsystem 16 captures images from display 20, using rolling shutter 13. For purposes of the positioning process, as described in the above-incorporated U.S. Pat. No. 8,217,997 and U.S. Patent Application Publications Nos. US 2014/0062881 and US 2014/0111433, the image data in captured pairs of these images are subtracted, in process 74, in order to recover the positioning target and thus determine the location of display 20 at which pointing device 10 is aimed. Processes 72, 74 etc. are repeated in the normal operation of pointing device 10 in carrying out this positioning operation.

According to embodiments of this invention, phase synchronization process 75 is performed to synchronize the timing of image capture with the release of frames to display 20 to avoid the situations described above relative to FIGS. 4a through 4h. It is contemplated that phase synchronization process 75 may be performed in parallel with the positioning process operating on subtracted images from process 74, for example in a continuous manner during operation, or alternatively phase synchronization process 75 may be performed prior to initiation of the positioning process to avoid the effects of erroneous positioning and control of the display system. Further in the alternative, it is contemplated that phase synchronization process 75 may be performed, either initially or during operation, after positioning has been performed, for example in response to the positioning process itself determining that accurate positioning cannot be performed.

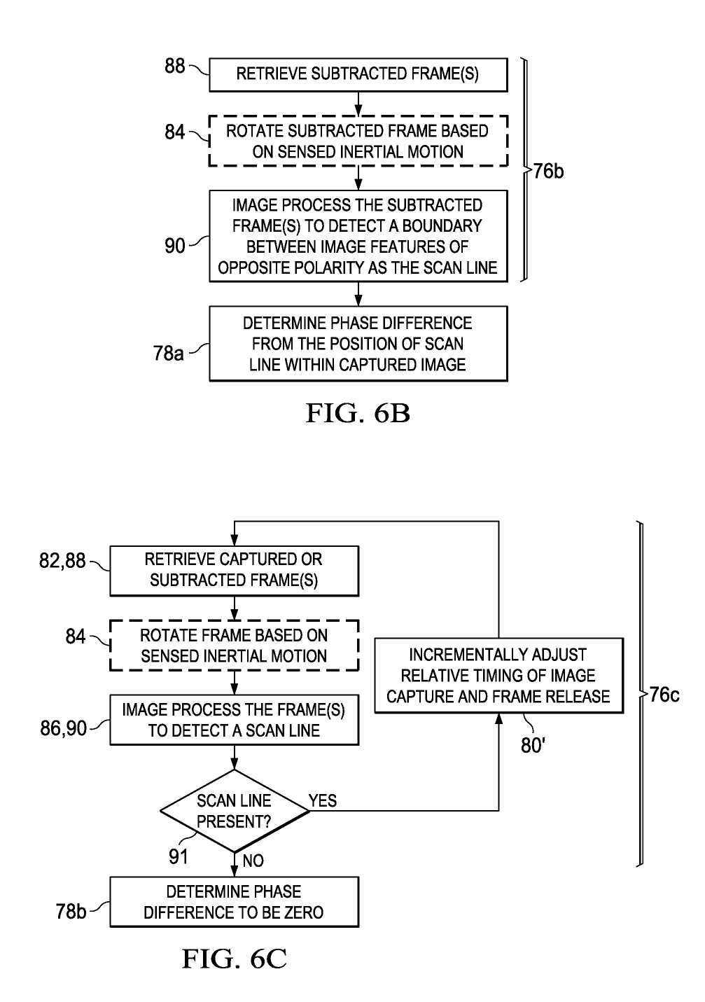

According to embodiments of the invention, phase synchronization process 75 begins with process 76, in which scan line detection circuitry 30 detects the position of a scan line in images captured by image capture subsystem 16. As indicated in FIG. 5 and as will be described in further detail below, the captured images that are analyzed in process 76 may be one or more images as captured in process 72, or alternatively may be the captured images after subtraction process 74. The subtracted images, following process 74, correspond to images such as shown in FIG. 3 and FIGS. 4f through 4h, in which ideally the human-visible payload portion of the images will cancel out and positioning targets will remain. Various alternative approaches to scan line detection process 76 are contemplated, as will now be discussed in connection with FIGS. 6a through 6c.

Once the scan line position has been detected in process 76, phase detection circuitry 32 executes process 78 to determine a phase difference between the timing of image capture and that of the release of a frame to display 20, based on the position of the scan line determined in process 76. It is contemplated that process 78 will typically be based on a transform from the spatial position of the scan line in the captured or subtracted image as determined in process 76 into a temporal relationship of that scan line position relative to the period of the frame rate. As such, it is contemplated that the specific approach involved in process 78 will be apparent to those skilled in the art having reference to this specification. If phase detection circuitry 32 is implemented in pointing device 10, as shown in the example of FIG. 2a, process 78 will be performed without involving computer 22 or communication between pointing device 10 and computer 22. On the other hand, if phase detection circuitry 32 is implemented externally from pointing device 10, such as in or in combination with computer 22 as in the example of FIG. 2b, process 78 will involve the communication of data between transceivers 18′ and 24′ to communicate data indicating the position of the scan line as determined in process 76 to phase detection circuitry 32, and the communication of data in the reverse direction to communicate the results of process 78 back to pointing device 10.

Following the determination of the phase difference in process 78, according to embodiments of the invention, process 80 is then performed by phase adjustment circuitry 34 to adjust the relative phase of image capture and the release of frames to display 20. Specific implementations of process 80 will be described in detail below by way of example. In general, process 80 may be performed by adjusting the timing of image capture by image capture subsystem 16 in pointing device 10, in which case phase adjustment circuitry 34 will be realized in pointing device 10, or alternatively by adjusting the timing of the release of display image frames to display 20, in which case phase adjustment circuitry 34 will be realized in computer 22, graphics adaptor 27, or projector 21 in the implementations of FIGS. 2a through 2c. Of course, phase adjustment process 80 may be performed at both locations, if desired. Accordingly, as suggested in FIG. 5, upon the completion of relative phase adjustment process 80, either or both of processes 70, 72 are modified with the results of process 80. The display of image frames in process 70, the capture of images by pointing device 10 in process 72, subtraction process 74, and the remainder of the positioning process are then performed, using the adjusted relative timing and thus at the improved accuracy resulting from phase synchronization of the image capture with frame release.

Particular embodiments of the manner in which scan line detection process 76 may be implemented will now be described in connection with FIGS. 6a through 6c.

In the embodiment shown in FIG. 6a, scan line detection process 76a begins with process 82, in which captured image frames from process 72 are retrieved by scan line detection circuitry 30. Retrieval process 82 may be performed simply by retrieving image data from memory, for example if scan line detection circuitry 30 is implemented within pointing device 10; alternatively, retrieval process 82 may involve the communication of image data via transceivers 18′, 24′ if scan line detection circuitry 30 is implemented by computer 22 or otherwise in connection with the display system.

In some embodiments, as discussed above, pointing device 10 may include inertial sensors 17 that are capable of detecting the relative motion of pointing device 10, including the rotation of pointing device 10 by the user. As discussed above relative to FIG. 4h, if pointing device 10 is rotated from its nominal position, any scan line in the captured (or subtracted) images will appear as rotated from the horizontal or vertical, as the case may be. Detection of a scan line is made more difficult by such rotation. Accordingly, following retrieval process 82, scan line detection process 76a may optionally include rotation process 84, by way of which scan line detection circuitry 30 receives a signal or data indicative of any rotation sensed by inertial sensors 17, and rotates the image or images retrieved in process 82 so as to re-orient the images in their nominal orientation, as though pointing device 10 were not rotated from its nominal position, facilitating the detection of a horizontal or vertical scan line in the images.

In process 86, scan line detection circuitry 30 processes the retrieved images according to conventional image processing algorithms to detect any linear region of high noise in the image or images. As discussed above, it is contemplated that the mis-synchronization of image capture relative to frame release will often present a region of high spatial noise (e.g., significant high frequency variations) at the locations of the image obtained during a transition from one displayed image frame to the next. Accordingly, process 86 analyzes the retrieved image, for example by applying a spatial frequency transform algorithm, to determine whether a linear region of high noise is present, and if so, the position of that region within the image.

The result of process 86, and thus of scan line detection process 76a, is then forwarded to phase detection circuitry 32 for determination of the phase difference in process 78. In the embodiment of FIG. 6a, phase difference determination process 78a may be performed by phase difference detection circuitry 32 executing a transform from the spatial position of the scan line in the captured or subtracted image as determined in process 76a into a temporal relationship of that scan line position relative to the period of the frame rate. Other approaches may, of course, alternatively be used. The resulting phase difference determined in process 78a is then forwarded to phase adjustment circuitry 34 for adjustment of the relative timing of image capture to frame release, as discussed above.

In an alternative implementation of scan line detection process 76a described above relative to FIG. 6a, processes 82, 84, 86 are performed on subtracted images from process 74, rather than the “raw” captured images from process 72. As noted above, subtracted frames ideally little or no payload image information, which cancels out in the subtraction, but may contain positioning target patterns that are reinforced by subtraction process 74. And, as shown in FIGS. 4g and 4h discussed above, the subtracted images also can include a region of high noise corresponding to scan line SL. It is contemplated that process 86 can readily identify such scan lines SL from the subtracted images; indeed, it is contemplated that it may be easier to detect the linear noise region corresponding to scan line SL in subtracted images than in the raw captured images. The resulting position information is then forwarded to phase difference detection circuitry 32 as before.

FIG. 6b illustrates another approach to scan line detection process 76 according to an embodiment of the invention. In this embodiment, scan line detection process 76b begins with the retrieval of one or more subtracted frames, in process 88, following subtraction process 74 as used in the positioning process. The retrieved subtracted frames are optionally rotated in process 84 based on information from inertial sensors 17 (if present), as described above.

In process 90, scan line detection circuitry 30 performs an image processing routine on the retrieved subtracted image or images to detect a boundary between image features of the opposite polarity. Referring back to FIG. 4g, discussed above, scan line SL is located at a boundary, on one side of which positioning target portion PT+ appears as a dark feature on a light background, and on the other side of which positioning target portion PT− appears as a light feature on a dark background. As mentioned above, subtraction process 74 tends to cancel out common features in the subtracted image frames, and as such positioning target portions PT+, PT− are expected to be readily visible in the subtracted images, at least away from scan line SL. It is contemplated that those skilled in the art having reference to this specification will be readily able to implement the appropriate image processing routine for identifying such complementary polarity features as positioning target portions PT+, PT− of FIG. 4g, and for estimating the position of a boundary between those complementary features, without undue experimentation. The position of scan line SL is thus determined in process 90 at the boundary between those complementary features.

The result of process 90 is then forwarded to phase detection circuitry 32 for determination of the phase difference in process 78a, in the same manner as discussed above relative to FIG. 6a, for example by executing a transform from the spatial position of the scan line in the captured or subtracted image as determined in process 76b into a temporal relationship of that scan line position relative to the period of the frame rate. The resulting phase difference is then forwarded to phase adjustment circuitry 34 for adjustment of the relative timing of image capture to frame release, as before.

FIG. 6c illustrates another embodiment of scan line detection process 76 according to an embodiment of the invention. In this embodiment, scan line detection process 76c essentially operates by identifying the absence of a scan line in the analyzed images. As such, this embodiment of scan line detection process 76c is incorporated in combination with phase adjustment process 80′, such that both processes are iteratively performed together. In other words, upon completion of process 76c, the relative timing of image capture and frame release will have already been adjusted.

For purposes of this embodiment, either raw captured images from process 82 or subtracted images from process 74 may be used in the scan line detection. Scan line detection process 76c thus begins with either of retrieval processes 82 or 88, depending upon whether raw captured images or subtracted images are to be analyzed. In either case, rotation process 84 is then optionally performed to de-rotate the retrieved image or images according to information from inertial sensors (17), if present. The retrieved images are then processed, for example by either of image processing processes 86, 90 described above or by another similar approach, to detect whether a scan line is present in the images. For purposes of this embodiment, it is not essential that the position of the scan line within the image be identified in process 86, 90; rather, the images need only be processed to determine whether a scan line is present. In particular, processes 86, 90 may be performed simply to determine whether the images are sufficiently clear (i.e., noise-free) to identify positioning targets; if not, then the presence of a scan line can be assumed.

In decision 91, scan line detection circuitry 30 evaluates the results of process 86, 90. If a scan line is present (decision 91 is “yes”), phase adjustment process 80′ is performed to incrementally adjust the timing of image capture relative to the release of display image frames to display 20 by, by adjusting either or both of image capture subsystem 16 or the display system (computer 22, graphics adaptor 27, or projector 21). Retrieval process 82, 88, optional rotation process 84, and image processing process 86, 90 are then repeated, and decision 91 is again evaluated. As mentioned above, knowledge of the phase difference indicated by the scan line position is not essential, nor is the polarity of the phase adjustment applied in process 80′ critical; the iterative nature of this approach will eventually settle on proper synchronization. However, as will be described below, convergence to synchronized operation can occur more rapidly if the phase difference and preferred polarity of adjustment were taken into consideration. Upon decision 91 determining that no scan line is present or that the image quality is sufficient to accurately perform the positioning process (decision 91 is “no”), the result is forwarded to process 78b, which in this embodiment determines that the phase difference is zero (i.e., no scan line is present, and therefore image capture and frame release are synchronized).

It is contemplated that scan line detection process 76c in this embodiment will be particularly useful in those implementations in which the mis-synchronized state does not exhibit a visible scan line, but rather results in a raw or subtracted image that is essentially noise over most if not all of the image field. This situation may present itself if the duration of the rolling shutter exposure is relatively long, occupying much of the period of the display frame.

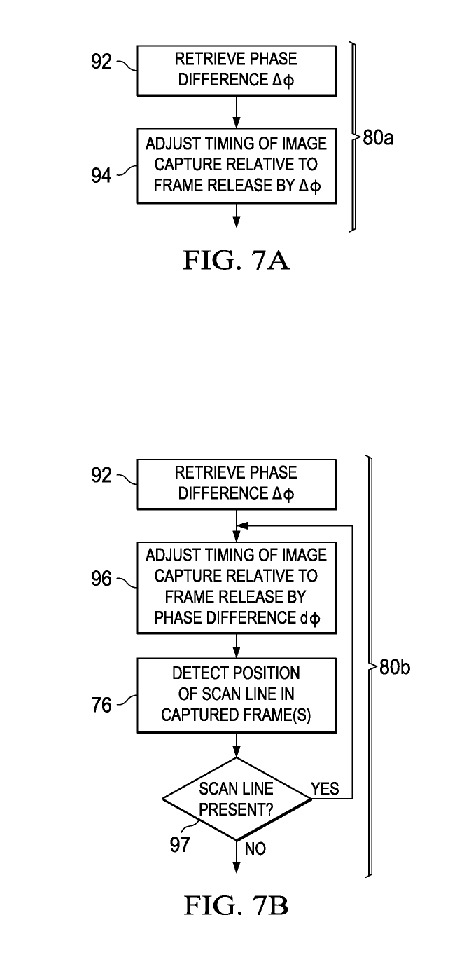

Particular embodiments of the manner in which phase adjustment process 80 may be implemented will now be described in connection with FIGS. 7a and 7b.

Phase adjustment process 80a as shown in FIG. 7a relies upon a value of the phase difference Δφ as determined in process 78. In this embodiment, that phase difference Δφ is retrieved by phase adjustment circuitry 34 from phase difference detection circuitry 32, in process 92. If phase difference detection circuitry 32 and phase adjustment circuitry 34 are both implemented in pointing device 10, as shown in the example of FIG. 2a, process 80a will be performed without involving computer 22 or communication between pointing device 10 and computer 22. On the other hand, if phase detection circuitry 32 is implemented externally from pointing device 10, such as in or in combination with computer 22 as in the example of FIG. 2b, process 92 will involve the communication of data between transceivers 18′ and 24′ to communicate a signal or indicating the phase difference determined in process 78 to phase adjustment circuitry 34 in pointing device 10. Conversely, of course, if phase adjustment circuitry 34 is realized in the display system of computer 22, graphics adaptor 27, and projector 21, communications will occur in the other direction.

In process 94, phase adjustment circuitry 34 applies the phase difference Δφ to either or both of image capture subsystem 16 in pointing device 10, or to the appropriate component of the display system if the timing of frame release to display 20 is to be adjusted. In the case of adjustment of the timing of image capture subsystem 16 in pointing device 10, it is contemplated that adjustment process 94 may be carried out in any one of a number of ways, depending on the particular implementation of image capture subsystem 10. For example, if the image capturing timing is a programmable parameter in image capture subsystem 16, timing adjustment process 94 may be performed by altering a timing parameter stored in a control register or other operative memory element of image capture subsystem 16, or by issuing a software or firmware command to logic circuitry in image capture subsystem 16. In other cases, adjustment of the timing of operation of image capture subsystem 16 may be performed by issuing a hardware synchronization signal (e.g., a “sync” pulse) to the appropriate circuitry. Conversely, phase adjustment process 94 may be similarly performed to adjust the timing of frame release, for example by similarly updating a software/firmware register within, or by issuing a hardware synchronization signal to, the appropriate component of the display system (computer 22, graphics adaptor 27, projector 21). It is contemplated that those skilled in the art having reference to this specification will be readily able to realize the adjustment of this relative timing in process 80a for particular implementations, without undue experimentation.

FIG. 7b illustrates phase adjustment process 80b according to an alternative implementation, in which the relative timing of image capture and frame release is incrementally adjusted. Process 92 is again performed by phase adjustment circuitry 34 to retrieve the phase difference Δφ determined in process 78. In this embodiment, an incremental adjustment is applied to image capture subsystem 16 or to the appropriate component of the display system (computer 22, graphics adaptor 27, projector 21), to advance or retard the timing of image capture or frame release by increment dφ. This increment dφ may vary, depending on the value of the retrieved phase difference Δφ, or instead may be a constant increment, for example at or near the smallest timing increment available. Similarly as described above relative to FIG. 6c, process 76 is then performed by scan line detection circuitry 30 to detect the position or presence of a scan line in the captured or subtracted images, in the manner described above. If a scan line is present (decision 97 is “yes’), the relative timing is again incrementally adjusted in process 96, and scan line detection process 76 is performed again. It may be desirable, in some implementations, to accelerate convergence to a synchronized state by adjusting the timing adjustment increment dφ according to the newly detected position of the scan line in process 76 within an iteration of process 80b. The process continues until no scan line is present (decision 97 returns a “no” result), indicating that synchronization has been attained.

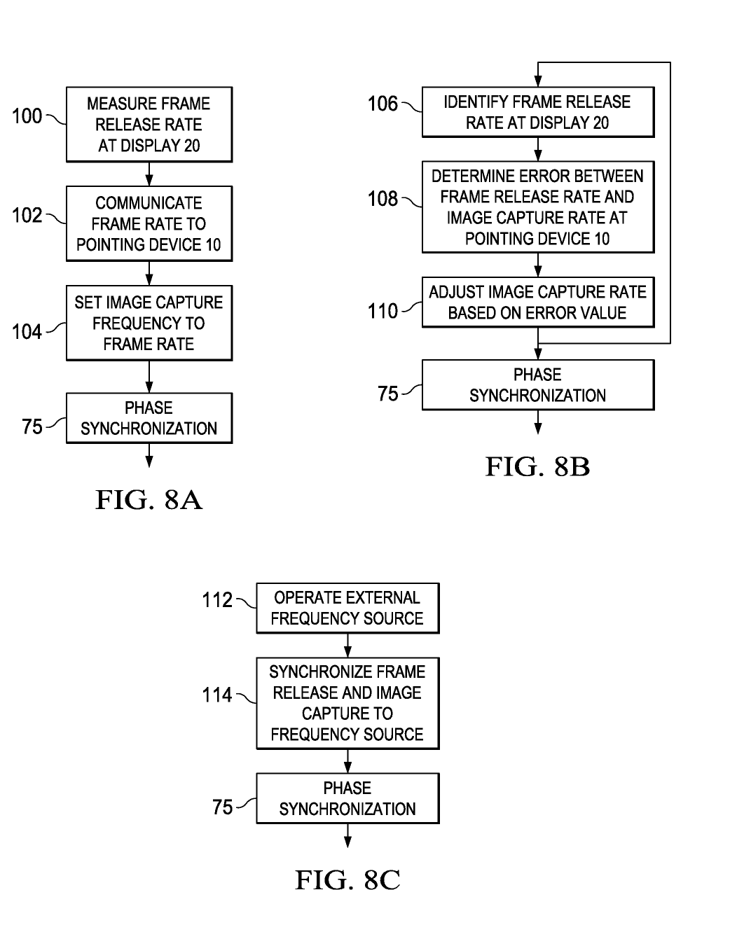

As mentioned above, frequency synchronization of the frequency at which image capture subsystem 16 acquires images and the rate at which display frames are “released” to display 20 by the display system (computer 22, graphics adaptor 27 or projector 21, as the case may be) can assist in the operation of some embodiments of the invention. These embodiments will now be described in connection with FIGS. 8a through 8c, in which optional processes for attaining frequency synchronization in advance of phase synchronization process 75 described above will be described in connection with additional embodiments of the invention.

FIG. 8a illustrates a first embodiment of this optional frequency synchronization. In process 100, the rate at which frames are released to display 20 is measured or otherwise identified. It is contemplated that any one of a number of approaches may be used to carry out process 100, including interrogation of a control register or other setting of graphics adaptor 27 (e.g., by computer 22), use of a counter to actually measure the time elapsed between sync or other signals indicative of the frame rate, and the like. It is contemplated that this process 100 will be carried out at the display system. In process 102, the frame release rate measured in process 100 is communicated to pointing device 10, for example by way of signals communicated by transceiver 24′ to transceiver 18′ in the architecture of FIG. 2b; these communicated signals may include data indicating the rate, or alternatively may be in the form of a “beat” signal every frame or so. Upon receiving that indication of the frame release rate communicated in process 102, image capture subsystem 16 sets its image capture rate to a frequency consistent with the frame release rate, in process 104. This frequency synchronization may be performed by synchronizing an internal clock in pointing device 10 to the communicated rate (or “beat” signal) of an internal clock at the display system (computer 22, graphics adaptor 27, or projector 21). Image capture can then commence, or continue as the case may be, along with phase synchronization process 75, for example according to one of the embodiments described above. By synchronizing the frequency between image capture and frame release, it is contemplated that the extent of the correction required of phase synchronization process 75 will be reduced.

An alternative frequency synchronization approach to that of FIG. 8a may be implemented by pointing device 10 identifying the rate at which image capture subsystem 16 is capturing images, and then communicating that image capture rate (or “beat” signal) to computer 22 via the wireless link from transmitter 18 to receiver 24. Upon receiving that image capture rate, the appropriate one of computer 22, graphics adaptor 27, or projector 21 at the display system sets the rate at which it releases frames to display 20 to a frequency consistent with the communicated image capture rate from pointing device 10. Image capture can then commence or continue, as the case may be.

FIG. 8b illustrates a phase-locked loop approach to frequency synchronization, according to an alternative embodiment, which is carried out at pointing device 10. This approach begins with process 106, in which pointing device 10 identifies the release rate of frames to display 20. Process 106 may be performed in a number of ways, for example by receiving sync signals or other start-of-frame indications from the display system, or alternatively by detecting scan lines or other events in captured images. Circuitry in pointing device 10 then identifies a frequency error between the frame release rate obtained in process 106 and the current image capture rate, in process 108. This frequency error value is used to adjust the image capture rate at image capture subsystem 16, in process 110, in a direction and by a value that reduces the frequency error. Processes 106, 108, 110 are then repeated in “PLL” fashion to maintain the two frequencies in synchronization. Phase synchronization process 75 can then be carried out, for example according to one of the embodiments described above, preferably in parallel with the continued frequency synchronization processes of this embodiment.

FIG. 8c illustrates another approach to frequency synchronization, particularly in connection with the architecture of FIG. 2c in which external frequency source 36 is provided. In process 112, this external frequency source 36 is operated to generate one or more clock signals for synchronizing the frequency of image capture and frame release. In process 114, clock signals are communicated to pointing device 10 and the display system (i.e., one of computer 22, graphics adaptor 27, and projector 21) as a frequency reference, with which image capture subsystem 16 synchronizes its image capture rate, and with which the display system synchronizes its frame release rate. In some implementations, it is contemplated that external frequency source 36 may be removed from pointing device 10 after frequency synchronization, particularly if circuitry is provided within pointing device 10 to maintain a constant image capture rate. In this alternative, external frequency source 36 may actually be a clock reference in computer 22, with which pointing device 10 is frequency-synchronized upon initializing its operation. As in the other embodiments, once frequency synchronization is attained in process 114, phase synchronization process 75 may then be performed as described above.

Other alternative approaches to attaining frequency synchronization are also contemplated. For example, an internal clock in pointing device that controls the rate of image capture system 16 may be synchronized to an internal clock in the display system (i.e., in computer 22, graphics adaptor 27, or projector 21) that controls the release of frames to display 20, or vice versa. This frequency synchronization of the respective internal clocks may be accomplished by one of pointing device 10 or the display system communicating its internal clock rate (or “beat” signal) to the other, for example over the wireless communication link between transceivers 18′, 24′ in the arrangement of FIG. 2b. In addition, frequency synchronization according to any of these approaches and other alternatives may be performed periodically during operation, if desired, or alternatively only at startup and then when needed or requested.

According to this embodiments of this invention, therefore, improvement in the ability of a pointing device to operate and control an interactive display system is provided. Specifically, the positioning of the location of a display at which a remote pointing device is aimed, and thus the displayed graphics or text element that is to be controlled by the user by way of the pointing device, can be more accurately and reliably be carried out, by ensuring good fidelity in the images captured by the pointing device for use in the positioning process. Some of the embodiments described enable the benefits of image capture synchronization to be attained over a wide range of display types, without requiring reconfiguration of the display system. It is contemplated that these advantages as applied to the absolute positioning process will significantly improve the operation of the interactive display system, as well as the experience provided to the audience.

While this invention has been described according to its embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A method of operating a computer system including a handheld human interface device, comprising:
generating visual payload image frame data;
combining at least one positioning target pattern with the visual payload image frame data for display in a sequence of consecutive frames;
periodically releasing the combined visual payload image frame data and positioning target pattern to a display;
periodically capturing, at the handheld human interface device, images representative of at least a portion of the display including the positioning target from which a location of the display at which the device is pointing can be determined, the capturing performed by the device in a scanned manner;
detecting a position of a scan line in one or more captured images, the scan line corresponding to a boundary between consecutive frames released to the display;
determining a phase difference between the periodic capturing of images at the device and the periodic releasing of frame data to the display; and
adjusting the timing of the periodic capturing of images at the device relative to the periodic releasing of frame data to the display according to the determined phase difference.

2. The method of claim 1, wherein at least one positioning target pattern corresponding to complementary intensity variances at one or more selected pixel locations of the visual payload image frame data, applied in first and second consecutive frames;
and further comprising:
subtracting image data from the first and second captured images from one another to recover the positioning target pattern as viewed at the device; and
determining a location of the display at which the device is pointing, responsive to the recovered positioning target pattern.

3. The method of claim 2, wherein the step of detecting a position of a scan line comprises:
after the subtracting step, detecting a location of the subtracted image data having increased noise relative to other locations of the subtracted image data.

4. The method of claim 2, wherein the step of detecting a position of a scan line comprises:
after the subtracting step, detecting a portion of a recovered positioning target of a first polarity adjacent to a portion of the recovered positioning target of a second polarity; and
identifying a boundary between the detected portions of the recovered positioning target of the first and second polarities as the position of a scan line.

5. The method of claim 1, wherein the step of detecting a position of a scan line comprises:
detecting a location of a frame of the captured image having increased statistical variance of pixel values relative to other locations of the frame.

6. The method of claim 1, further comprising:
detecting rotational motion of the device based on measurements acquired from one or more motion sensors in the device; and
prior to the step of detecting a position of a scan line, orienting the one or more captured images according to the detected rotational motion.

7. The method of claim 1, wherein the step of detecting a position of a scan line comprises:
identifying portions of a frame of a captured image at which a scan line does not appear; and
deducing the location of the scan line from the identified portions.

8. The method of claim 1, wherein the step of adjusting the timing of the periodic capturing of images comprises:
iteratively modifying the timing of the image capture by an increment and repeating the step of detecting a position of the scan line until the scan line is not visible in a captured frame.

9. The method of claim 1, wherein the step of adjusting the timing of the periodic capturing of images comprises:
modifying the timing of the image capture by an amount corresponding to the phase difference.

10. The method of claim 1, wherein the step of adjusting the timing of the periodic capturing of images relative to the periodic releasing of frame data to the display comprises;
communicating the phase difference to a display system; and
at the display system, adjusting the timing of the releasing of frame data by an amount corresponding to the phase difference.

11. The method of claim 1, further comprising:
synchronizing a rate at which the device periodically captures image data and a display frame rate at which frames are periodically released to the display; and
then performing the capturing, detecting, determining and adjusting steps.

12. The method of claim 11, wherein the synchronizing step comprises:
determining a display frame rate at which the frame data are periodically released to the display;
communicating the display frame rate to the device;
operating the device to periodically capture images at a rate corresponding to the display frame rate; and
then performing the capturing, detecting, determining and adjusting steps.

13. The method of claim 11, wherein the synchronizing step comprises:
synchronizing both the device and a display system that performs the periodic releasing of frame data to an external source.

14. The method of claim 11, wherein the synchronizing step comprises:
determining an image capture rate at which the device periodically captures images;
communicating the image capture rate to a display system that performs the periodic releasing of frame data;
operating the display system to periodically release frames at a rate corresponding to the image capture rate; and
then performing the capturing, detecting, determining and adjusting steps.

15. The method of claim 11, wherein the synchronizing step comprises:
synchronizing clock rates of an internal clock of a display system and an internal clock of the device.

16. An interactive display system, comprising:
a computer for generating display image data comprising visual payload image data combined with at least one positioning target pattern;
graphics output circuitry for periodically releasing frames of the display image data to a display;
a pointing device, comprising:
a hand-held housing;
an image sensor disposed in the housing;
image capture circuitry for periodically capturing, in a scanned manner, image data obtained by the image sensor; and
scan line detection circuitry for detecting a position of a scan line in one or more captured images, the scan line corresponding to a boundary between consecutive frames released to the display;
positioning circuitry for determining a location at the display at which the pointing device is aimed from the captured image data;
circuitry for determining a phase difference between the periodic capturing of images at the device and the periodic releasing of frame data to the display; and
circuitry for adjusting the timing of the periodic capturing of images at the device relative to the periodic releasing of frame data to the display according to the determined phase difference.

17. The system of claim 16, wherein the determining circuitry is implemented in the computer;
wherein the adjusting circuitry is implemented in the pointing device;
and further comprising:
communications circuitry in the computer for communicating the phase difference to the pointing device; and
communications circuitry at the pointing device for communicating the scan line position to the computer and for receiving the phase difference.

18. The system of claim 17, wherein the adjusting circuitry comprises:
circuitry for modifying contents of a memory element, the memory element storing a number of scan lines per frame in one or more captured images.

19. The system of claim 17, wherein the adjusting circuitry comprises:
circuitry for applying a hardware sync signal to the image capture circuitry.

20. The system of claim 16, wherein the determining circuitry and adjusting circuitry are implemented in the pointing device.

21. The system of claim 16, wherein the determining circuitry is implemented in the pointing device;
wherein the adjusting circuitry is implemented in the computer;
and further comprising:
communications circuitry in the pointing device for communicating the phase difference to the pointing device; and
communications circuitry at the computer for receiving the phase difference.

22. The system of claim 16, further comprising:
an external rate source, in communication with the pointing device and the computer, for synchronizing a rate at which the image capture subsystem periodically captures image data to a display frame rate at which the graphics output circuitry periodically releases frames to the display.

23. The system of claim 16, further comprising:
communications circuitry in the pointing device and at the computer, for wirelessly communicating with one another; and
internal clocks in the pointing device and at the graphics output circuitry, one of the internal clocks arranged to synchronize its frequency to a frequency of the other of the internal clocks as communicated via the communications circuitry.

24. The system of claim 16, wherein at least one positioning target pattern corresponds to complementary intensity variances at one or more selected pixel locations of the visual payload image frame data, applied in first and second consecutive frames;
and wherein the positioning circuitry determines a location at the display at which the pointing device is aimed by performing a plurality of operations comprising:
subtracting image data from first and second successive captured images from one another to recover the positioning target pattern as viewed at the pointing device; and
determining a location of the display at which the device is pointing, responsive to the recovered positioning target pattern.

25. The system of claim 24, wherein the scan line detection circuitry detects the position of the scan line by detecting a location of the subtracted image data having increased noise relative to other locations of the subtracted image data.

26. The system of claim 24, wherein the scan line detection circuitry detects the position of the scan line by:
in the subtracted image data, detecting a portion of a recovered positioning target of a first polarity adjacent to a portion of the recovered positioning target of a second polarity; and
identifying a boundary between the detected portions of the recovered positioning target of the first and second polarities as the position of a scan line.

27. The system of claim 16, wherein the scan line detection circuitry detects the position of the scan line by:
detecting a location of a frame of the captured image having increased statistical variance of pixel values relative to other locations of the frame.

28. The system of claim 16, wherein the pointing device further comprises:
one or more motion sensors;
and wherein the scan line detection circuitry detects the position of the scan line, after orienting the one or more captured images according to rotational motion of the pointing device detected from measurements acquired from the motion sensors.
